(19) United States
(12) Patent Application Publication
(10) Pub. No.: US 2011/0291432 A1
(43) Pub. Date: Dec. 1, 2011

(54) DISPOSABLE DOG WASTE HANDLING DEVICE

(75) Inventor: Robert Machado, New York, NY (US)

(73) Assignee: MADISON STREET INNOVATIONS LLC, New York, NY (US)

(21) Appl. No.: 13/118,763

(22) Filed: May 31, 2011

Related U.S. Application Data
(60) Provisional application No. 61/349,715, filed on May 28, 2010.

(51) Int. Cl. A01K 29/00

(52) U.S. Cl. 294/1.3

(57) ABSTRACT

A disposable dog waste handling device includes a framework; and a flexible bag, attached to the framework, having a portion capable of lying flat under the dog to capture feces eliminated from the dog, the bag adapted to retain the feces when the device is lifted. The device may be operated by a user using one hand so that, when the user lifts an end of the framework, the bag retains the feces and the user does not feel the eliminated feces. The framework includes a strip of flexible material that forms a loop, and the bag may not detach from the material. The entire device is then thrown away.

### RELATED APPLICATIONS

This application claims the benefit of the filing date of U.S. patent application Ser. No. 61/349,715, filed May 28, 2010, which is incorporated herein by reference in its entirety.

### BACKGROUND OF THE INVENTION

The present invention generally relates to pet products and more specifically to a disposable dog waste bag.

Existing dog waste removal products may require the user to manipulate bags or materials where the user may come in contact with the waste. The user may be required to use other equipment, or the user might feel the texture and temperature of the waste through the bag.

It would be desirable to have a fully disposable dog waste handling device.

### SUMMARY OF THE INVENTION

In one aspect of the present invention, a device includes a framework; and a flexible bag, having a first portion capable of lying flat to capture feces eliminated from an animal, and having a second portion that attaches to the framework so that the bag retains the feces when the device is lifted.

In another aspect of the present invention, a disposable dog waste handling device includes a framework; and a flexible bag, attached to the framework, having a portion capable of lying flat under the dog to capture feces eliminated from the dog, the bag adapted to retain the feces when the device is lifted; wherein the device may be operated by a user using one hand so that, when the user lifts an end of the framework, the bag retains the feces and the user does not feel the eliminated feces.

### BRIEF DESCRIPTION OF THE DRAWINGS

FIG. 1 is a top-right perspective view of one embodiment illustrating use with a dog;

FIG. 2 is a top-right perspective view of the embodiment of FIG. 1 illustrating lifting of the bag after use;

FIG. 3 is a right-side elevational view of the embodiment of FIG. 1 illustrating a closed bag configuration;

FIG. 4 is a top elevational view of the embodiment of FIG. 1 in an open configuration;

FIG. 5 is a top elevational view of the embodiment of FIG. 1 in the closed configuration;

FIG. 6 is an exploded-right perspective view of the embodiment of FIG. 1;

FIG. 7 is a side view of a second embodiment of the present invention;

FIG. 8 is a top view of the embodiment of FIG. 7 being lifted by a user; and

FIG. 9 is a top view of the embodiment of FIG. 7 after use.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a fully disposable dog waste bag that may be placed under the dog while it goes to the bathroom, which then may be lifted and then thrown away.

An embodiment of the present invention may provide a fully-disposable bag that has a built-in framework so the bag can be placed on the ground before a dog or other animal or pet goes to the bathroom. Embodiments of a bag can then be lifted using the framework so the entire unit can be disposed of without the person ever feeling the dog's feces or carrying a non-disposable framework or handle around afterwards.

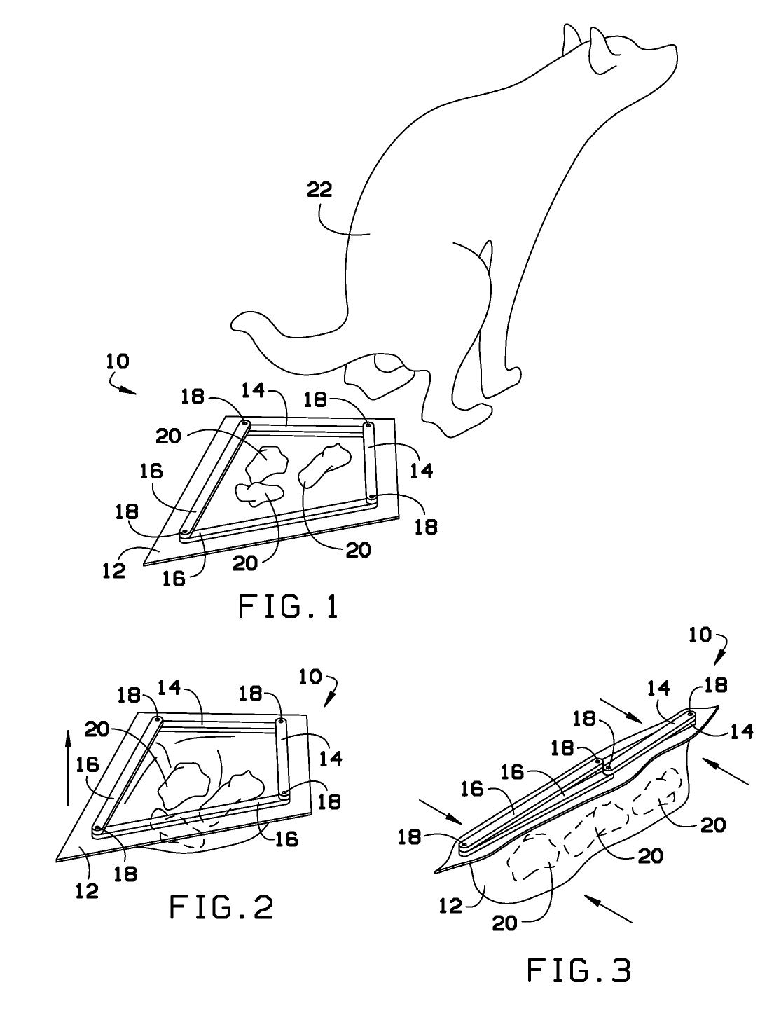

With reference to FIG. 1, a top-right perspective view of one embodiment illustrating use of the dog waste handling device 10 in use with a dog 22 is shown. In one embodiment, the dog waste handling device 10 may comprise a disposable bag 12, a short frame stick 14, a long frame stick 16, and a pivot pin 18. The fecal matter 20 eliminated by the dog 22 may be captured in the disposable bag 12. The disposable bag 12 may consist substantially of plastic, paper, or other low-cost material.

With reference to FIGS. 2 and 3, in one embodiment, a shaped sheet of low-cost material may be used to create the disposable bag 12 portion of the dog waste handling device 10. In one embodiment, frame sticks 14 and 16 may be used generally as frame work to form a disposable loop.

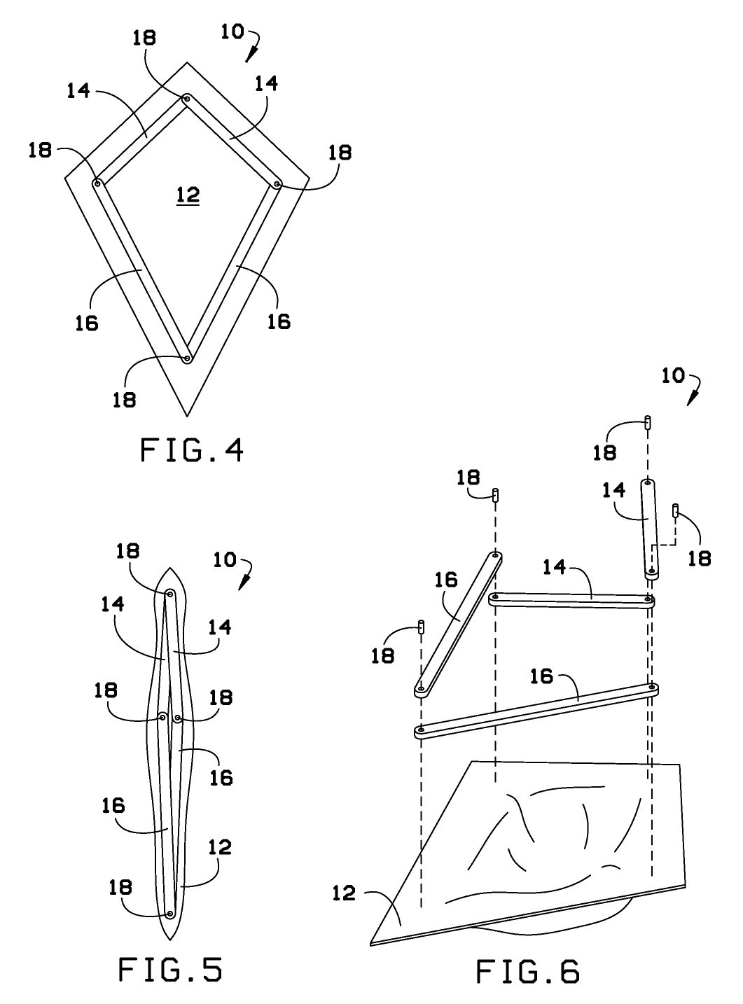

With reference to FIG. 4, embodiments of a disposable bag 12 may be cut into a shape and affixed to framework sticks 14 and 16 or other frame to provide a bag-type use. The disposable bag 12 may be used to hold the feces 20 once the dog 22 eliminates it. The disposable bag 12 may be made of plastic or a similar material suitable to form a low-cost bag.

With reference to FIG. 5, in one embodiment, the disposable framework sticks 14 and 16 or other frame may be used to give the dog waste handling device 10 a structure and weight. In a foldable embodiment, the device 10 can be opened using one hand, placed under the dog 22, and closed with one hand.

With reference to FIG. 6, in one embodiment, the framework sticks 14 and 16 may be from three inches to twelve inches in length depending the size of the bag 12 as it may relate to the size designed for different size dogs 22. In one embodiment, the disposable sticks 14 and 16 may be made from, by way of example and not by way of limitation, plastic or wood.

In one embodiment, the disposable bag 12 may be affixed to the framework sticks 14 and 16 using adhesive or a similar method so as to allow the framework sticks 14 and 16 to open and close the dog waste handling device 10 as well as give it weight to allow the device 10 to be placed under the dog once opened.

In one embodiment, optional elements may include longer framework sticks 14 and 16 to give the dog owner comfort that their hand will be farther away from the dog 22 and feces 20 when they are placing the bag under the dog. Another optional element may include a seal on the top of the bag 12 so as to seal in the feces 20 while it is transported for disposal or if it is stored in a garbage can for a longer period of time.

In one embodiment, two longer framework sticks 16 may be connected to each other at one end. They may be connected with connectors (screws, rivets, etc.) or pivot pin 18 which allows for a single point hinge motion to take place. The other end of each of the long framework sticks 16 may be attached to a short framework stick 14 with the same connector device. In one embodiment, the unconnected ends of two short framework sticks 14 may be connected to each other making a four sided, kite-like shape.

In one embodiment, the disposable bag 12 may be attached to the framework sticks 14 and 16 with an adhesive or by permanently sealing the disposable bag 12 around the framework sticks 14 and 16, thus creating a bag-like shape and one disposable device.

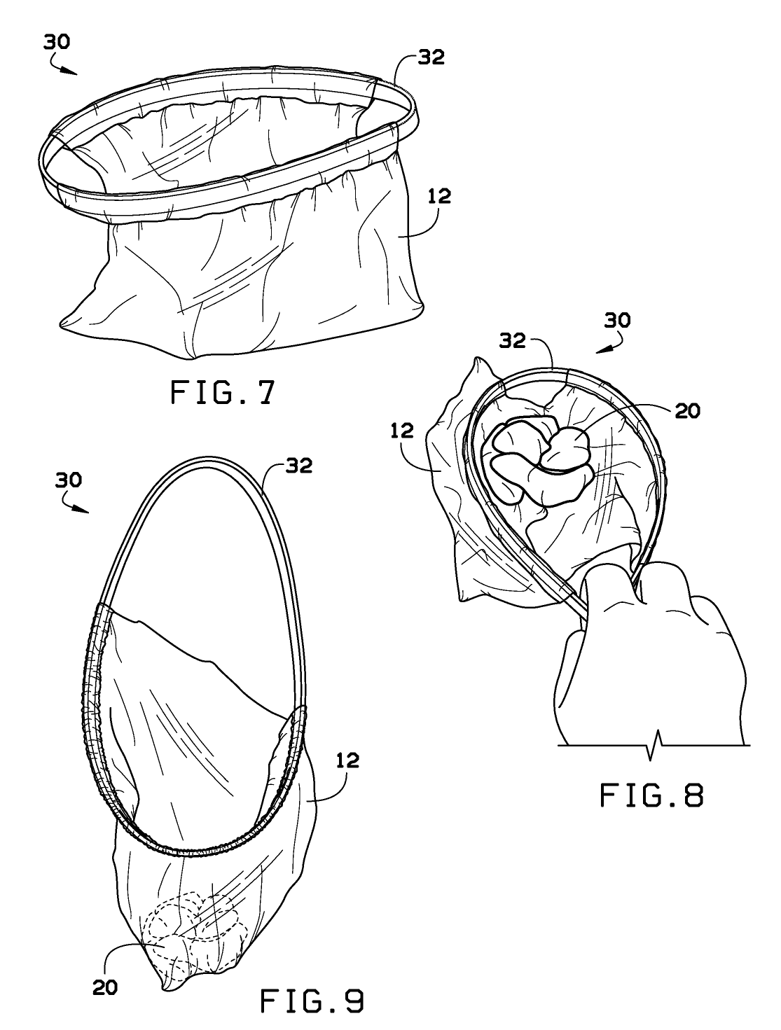

With reference to FIG. 7, in a second embodiment, a waste handling device 30 may have a curved frame 32 made of a single, flexible piece of material, such as plastic formed into a long, thin strip, which retains the disposable bag 12. The strip of material may be attached to itself at one end to form a generally teardrop-shaped loop. The device 30 may be operated utilizing one hand.

With reference to FIG. 8, a user may grasp one end of the curved frame 32 using one hand, to lift the entire waste handling device 30 that contains the feces 20.

With reference to FIG. 9, once the waste handling device 30 has been lifted, the disposable bag 12 will retain the feces 20 so that the entire device 30 may be disposed of without the user's hand coming near the feces 20.

In one embodiment, a method for using a dog waste handling device 10 comprises transporting the device 10 when taking the dog 22 out for a walk and making sure the device 10 is in a place which is easily accessible to the user. This is because once the dog 22 shows that it is preparing to eliminate, there will not be much time to act. Once the dog squats, getting ready to eliminate, the method continues by the user's pulling out the device 10 with one hand. The user then places the bag 12 under the dog 22. The user lays it on the ground in the best place that the user believes will catch the feces 20. Once the dog 22 is finished eliminating, the user picks up the device 10, thus retaining the feces 20 in the bag 12 and never having to feel the actual fecal material 20 through the plastic. The user disposes the entire device 10 in a trash receptacle, not having to reuse or carry any portion again.

It should be understood, of course, that the foregoing relates to exemplary embodiments of the invention and that modifications may be made without departing from the spirit and scope of the invention as set forth in the following claims.

I claim:

1. A device comprising:
a framework; and
a flexible bag, having a first portion capable of lying flat to capture feces eliminated from an animal, and having a second portion that attaches to the framework so that the bag retains the feces when the device is lifted.

2. The device of claim 1, wherein the framework is adapted to lie flat and be used under a dog.

3. The device of claim 1, wherein the device is small enough to be operated by a user using one hand.

4. The device of claim 1, wherein the framework is adapted so that, when a user lifts an end of the framework, the bag retains the feces and the user does not feel the eliminated feces.

5. The device of claim 1, wherein the flexible bag does not detach from the framework when the device is used, thereby forming a disposable dog waste handling device.

6. The device of claim 1, further comprising a seal to seal the feces in the bag.

7. The device of claim 1, wherein the framework includes a flexible piece of material that forms a curved frame.

8. The device of claim 1, wherein the framework includes a strip of material that is attached to itself to form a loop.

9. A disposable dog waste handling device comprising:
a framework; and
a flexible bag, attached to the framework, having a portion capable of lying flat under the dog to capture feces eliminated from the dog, the bag adapted to retain the feces when the device is lifted;
wherein the device may be operated by a user using one hand so that, when the user lifts an end of the framework, the bag retains the feces and the user does not feel the eliminated feces.

10. The device of claim 9, wherein framework includes a strip of flexible material that forms a loop, and the bag does not detach from the material.

11. A method for disposing of feces, comprising:
transporting a waste handling device while taking a dog for a walk, the waste handling device comprising a framework and a flexible bag;
when the dog prepares to eliminate, placing the device under the dog and laying a portion of the bag flat so that the bag captures the feces eliminated from the dog;
lifting an end of the framework so that the bag retains the feces and the user does not feel the eliminated feces; and
disposing of the entire device.

12. The method of claim 11, wherein the framework includes a strip of flexible material that forms a loop, and the bag does not detach from the material.
